(19) United States
(12) Patent Application Publication
(10) Pub. No.: US 2025/0148746 A1
(43) Pub. Date: May 8, 2025

(54) CHEMICAL SHIFT CODED IMAGING METHOD BASED ON TRANSITION REGION AND REGIONAL ITERATIVE PHASOR EXTRACTION

(71) Applicant: SHENZHEN INSTITUTES OF ADVANCED TECHNOLOGY CHINESE ACADEMY OF SCIENCES, Shenzhen (CN)

(72) Inventors: Hao PENG, Shenzhen (CN); Chao ZOU, Shenzhen (CN); Chuanli CHENG, Shenzhen (CN); Xin LIU, Shenzhen (CN); Hairong ZHENG, Shenzhen (CN)

(73) Assignee: SHENZHEN INSTITUTES OF ADVANCED TECHNOLOGY CHINESE ACADEMY OF SCIENCES, Shenzhen (CN)

(21) Appl. No.: 19/019,221

(22) Filed: Jan. 13, 2025

Related U.S. Application Data
(63) Continuation of application No. PCT/CN2023/133467, filed on Nov. 22, 2023.

(30) Foreign Application Priority Data
Nov. 23, 2022 (CN) 202211478156.1

(51) Int. Cl. G06V 10/25; G06V 10/26; G06V 10/36

(52) U.S. Cl. CPC G06V 10/25; G06V 10/267; G06V 10/36

(57) ABSTRACT

The present disclosure discloses a chemical shift coded imaging method based on a transition region and regional iterative phasor extraction. Acquiring an initial image, and determining an initial phasor solution of the transition region based on the initial image; performing regional iterative phasor extraction in at least two set directions by taking the initial phasor solution as initial information, and obtaining a target phasor solution based on a regional iterative phasor extraction result corresponding to each set direction; and determining a first chemical composition signal and a second chemical composition signal based on the target phasor solution, and performing chemical shift coded imaging based on the first chemical composition signal and/or the second chemical composition signal. By means of regional iterative phasor extraction in a plurality of dimensions, wrong phasor information is transferred independently along different dimensions, wrong information transferred in different directions is excluded.

### CROSS-REFERENCE TO RELATED APPLICATIONS

The application claims priority to Chinese patent application No. 202211478156.1, filed on Nov. 23, 2022, the entire contents of which are incorporated herein by reference.

### TECHNICAL FIELD

The present disclosure relates to the technical field of image processing, in particular to a chemical shift coded imaging method based on a transition region and regional iterative phasor extraction.

### BACKGROUND

A chemical shift coded imaging method is an imaging method that distinguishes different component signals based on a frequency difference of chemical shifts of a detected object. An imaged object is in different chemical environments, resulting in magnetic resonance signals thereof having different chemical shift frequencies. For example, a water-fat separation method that distinguishes signals of water and fat based on differences in chemical shift frequencies of hydrogen protons in the water and the fat is the most common chemical shift coded imaging method.

In a process of implementing the present disclosure, it was found that there are at least the following technical problems in the prior art: an existing chemical shift composition separation method obtains an accurate chemical shift composition separation result in some application scenarios, but the current method largely relies on determined initial information, such as a seed point. The seed point has strict requirements for a chemical composition content of a pixel. In some scanning scenarios and scanning parameters, it is difficult to find the seed point, which may cause algorithm instability, resulting in poor stability and low accuracy of chemical shift composition separation, and ultimately leading to a poor chemical shift coded imaging effect.

### SUMMARY

The present disclosure provides a chemical shift coded imaging method based on a transition region and regional iterative phasor extraction, so as to solve technical problems of poor stability and low accuracy of chemical shift composition separation caused by difficulty in accurately acquiring phasor information in a case where initial information is uncertain, ensure the stability and accuracy of chemical shift composition separation in the case where the initial information is uncertain, and improve a chemical shift coded imaging effect.

According to an aspect of the present disclosure, a chemical shift coded imaging method based on a transition region and regional iterative phasor extraction is provided and includes:
acquiring an initial image, and determining an initial phasor solution of the transition region based on the initial image;
performing regional iterative phasor extraction in at least two set directions by taking the initial phasor solution as initial information, and obtaining a target phasor solution based on a regional iterative phasor extraction result corresponding to each set direction; and
determining a first chemical composition signal and a second chemical composition signal based on the target phasor solution, and performing chemical shift coded imaging based on the first chemical composition signal and/or the second chemical composition signal.

Optionally, further, determining the initial phasor solution of the transition region based on the initial image includes:
determining foreground pixels based on pixel values of pixels in the initial image, and determining a phasor candidate solution of each foreground pixel; and
determining the transition region and the initial phasor solution of the transition region based on the phasor candidate solution of each foreground pixel.

Optionally, further, determining the foreground pixels based on the pixel values of the pixels in the initial image includes:
taking pixels with pixel values greater than a set amplitude value as the foreground pixels, wherein the set amplitude value is determined based on the pixel value of each pixel.

Optionally, further, performing regional iterative phasor extraction in the at least two set directions by taking the initial phasor solution as the initial information, and obtaining the target phasor solution based on the regional iterative phasor extraction result corresponding to each set direction includes:
obtaining the corresponding regional iterative phasor extraction result by taking the initial phasor solution as the initial information and performing regional iterative phasor extraction respectively in the set direction;
for each pixel determining target phasor information of the pixel according to phasor information in each regional iterative phasor extraction result corresponding to the pixel; and
determining a merged phasor solution based on the target phasor information of each pixel, and determining the target phasor solution based on the merged phasor solution.

Optionally, further, obtaining the corresponding regional iterative phasor extraction result by taking the initial phasor solution as the initial information and performing regional iterative phasor extraction respectively in the set direction includes:
for each set direction, conducting Hamming window filtering on the initial phasor solution in the set direction to obtain a filtered phasor, and determining an iterative phasor solution of the phasor according to the filtered phasor, wherein a magnitude of a window function of the Hamming window filtering is determined according to a resolution of the initial image in the set direction; and
taking the iterative phasor solution as new initial information, repeatedly executing the above steps until an iteration stop condition is reached, and determining the regional iterative phasor extraction result in the set direction.

Optionally, further, determining the target phasor information of the pixel according to the phasor information in each regional iterative phasor extraction result corresponding to the pixel includes:
when the phasor information in each regional iterative phasor extraction result corresponding to the pixel is consistent, taking the phasor information in the regional iterative phasor extraction result as the target phasor information of the pixel; and
when the phasor information in each regional iterative phasor extraction result corresponding to the pixel is inconsistent, setting zero as the target phasor information of the pixel.

Optionally, further, determining the target phasor solution based on the merged phasor solution includes:
obtaining the target phasor solution by performing regional iterative phasor extraction on the merged phasor solution.

According to another aspect of the present disclosure, a chemical shift coded imaging apparatus based on a transition region and regional iterative phasor extraction is provided and includes:
an initial phasor solution determining module, configured to acquire an initial image, and determine an initial phasor solution of the transition region based on the initial image;
a target phasor solution determining module, configured to perform regional iterative phasor extraction in at least two set directions by taking the initial phasor solution as initial information, and obtain a target phasor solution based on a regional iterative phasor extraction result corresponding to each set direction; and
a chemical shift coded imaging module, configured to determine a first chemical composition signal and a second chemical composition signal based on the target phasor solution, and perform chemical shift coded imaging based on the first chemical composition signal and/or the second chemical composition signal.

According to another aspect of the present disclosure, an electronic device is provided and includes:
at least one processor; and
a memory in communication connection with the at least one processor, wherein
the memory stores a computer program executable by the at least one processor, and the computer program is executed by the at least one processor, such that the at least one processor is capable of executing the chemical shift coded imaging method based on the transition region and the regional iterative phasor extraction described in any embodiment of the present disclosure.

According to another aspect of the present disclosure, a computer readable storage medium is provided, wherein the computer readable storage medium stores computer instructions, and the computer instructions are used to cause, when executed by the processor, the processor to implement the chemical shift coded imaging method based on the transition region and the regional iterative phasor extraction described in any embodiment of the present disclosure.

According to technical solutions of the embodiments of the present disclosure, the initial image is acquired, and the initial phasor solution of the transition region is determined based on the initial image; regional iterative phasor extraction is performed in the at least two set directions by taking the initial phasor solution as the initial information, and the target phasor solution is obtained based on the regional iterative phasor extraction result corresponding to each set direction; and the first chemical composition signal and the second chemical composition signal are determined based on the target phasor solution, and chemical shift coded imaging is performed based on the first chemical composition signal and/or the second chemical composition signal. By means of regional iterative phasor extraction in a plurality of dimensions, wrong phasor information is transferred independently along different dimensions, and then regional iterative phasor extraction results in a plurality of dimensions are merged to exclude wrong information transferred in different directions and reserve correct information consistent in each dimension, so as to solve the technical problems of poor stability and low accuracy of the separated chemical composition signals caused by difficulty in accurately acquiring the phasor information in a case where the initial information is uncertain, so that in the case where the initial information is uncertain, the separated chemical composition signals are more accurate, thereby improving the chemical shift coded imaging effect.

It should be understood that the content described in this part is not intended to identify key or important features of the embodiments of the present disclosure, and is not used to limit the scope of the present disclosure as well. Other features of the present disclosure will become easily understood through the following specification.

### BRIEF DESCRIPTION OF DRAWINGS

In order to illustrate technical solutions in embodiments of the present disclosure more clearly, accompanying drawings needing to be used in description of the embodiments will be introduced below briefly. Apparently, the accompanying drawings in the description below are only some embodiments of the present disclosure, and those ordinarily skilled in the art may further obtain other accompanying drawings according to these accompanying drawings without creative efforts.

FIG. 1 is a schematic flow diagram of a chemical shift coded imaging method based on a transition region and regional iterative phasor extraction provided by Embodiment 1 of the present disclosure.

FIG. 2 is a schematic flow diagram of a chemical shift coded imaging method based on a transition region and regional iterative phasor extraction provided by Embodiment 2 of the present disclosure.

FIG. 3 is a schematic diagram of a chemical shift coded imaging result based on a transition region and regional iterative phasor extraction provided by Embodiment 2 of the present disclosure.

FIG. 4 is a schematic structural diagram of a chemical shift coded imaging apparatus based on a transition region and regional iterative phasor extraction provided by Embodiment 3 of the present disclosure.

FIG. 5 is a schematic structural diagram of an electronic device provided by Embodiment 4 of the present disclosure.

### DETAILED DESCRIPTION OF THE EMBODIMENTS

In order to make those skilled in the art understand the solutions of the present disclosure better, the technical solutions in the embodiments of the present disclosure will be described below clearly and completely with reference to the accompanying drawings in the embodiments of the present disclosure. Obviously, the described embodiments are only part of the embodiments of the present disclosure, but not all the embodiments. On the basis of the embodiments in the present disclosure, all other embodiments obtained by those ordinarily skilled in the art without inventive efforts should fall within the scope of protection of the present disclosure.

It should be noted that terms “first”, “second”, and the like in the specification and the claim of the present disclosure and the above accompanying drawings are user to distinguish similar objects, and are not necessarily used to describe a specific sequence or a precedence sequence. It should be understood that data used in this way may be interchanged where appropriate, so that the embodiments of the present disclosure described here may be implemented according to sequences other than those illustrated or described here. In addition, terms “including” and “having” and any variations thereof are intended to cover but not exclusively contain, for example, a process, method, system, product or device containing a series of steps or units is not necessarily limited to those steps or units expressly listed, but may include other steps or units not expressly listed or inherent to these processes, methods, products or devices.

### Embodiment 1

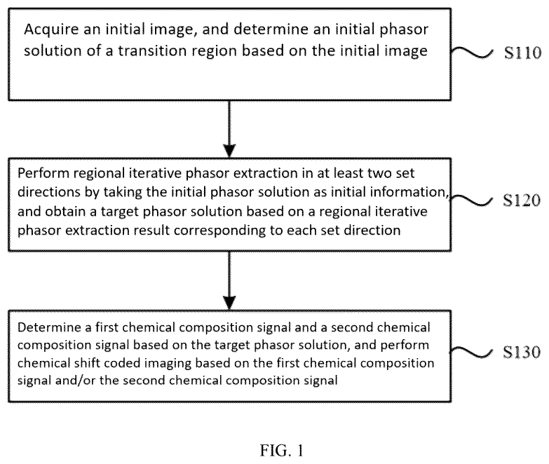

FIG. 1 is a schematic flow diagram of a chemical shift coded imaging method based on a transition region and regional iterative phasor extraction provided by Embodiment 1 of the present disclosure. This embodiment is applicable to a scenario in which chemical shift compositions are separated for chemical shift coded imaging, and particularly applicable to a scenario in which chemical shift coded imaging is performed in a case where initial information is uncertain. The method may be performed by a chemical shift coded imaging apparatus based on the transition region and the regional iterative phasor extraction. The chemical shift coded imaging apparatus based on the transition region and the regional iterative phasor extraction may be implemented in a form of hardware and/or software, and the chemical shift coded imaging apparatus based on the transition region and the regional iterative phasor extraction may be configured in an electronic device. As shown in FIG. 1, the method includes:

S110, an initial image is acquired, and an initial phasor solution of the transition region is determined based on the initial image.

In this embodiment, chemical shift coded imaging is performed based on the initial image. Optionally, the initial image may be an image reconstructed from magnetic resonance signals collected based on a magnetic resonance imaging method. It should be noted that this embodiment can achieve chemical shift coded imaging in a case where initial information is uncertain. Therefore, there are no restrictions on a collection manner of the initial image and parameters of a collection device (such as a magnetic field strength and a collection bandwidth). Even if the initial information in the initial image reconstructed based on the collected signals is uncertain, a water-fat signal can still be stably separated.

Optionally, a phasor solution of the transition region in the initial image may be calculated using either a transition region extraction method or a seed point identification method.

In an implementation of the present disclosure, determining the initial phasor solution of the transition region based on the initial image includes: determining foreground pixels based on pixel values of pixels in the initial image, and determining a phasor candidate solution of each foreground pixel; and determining the transition region and the initial phasor solution of the transition region based on the phasor candidate solution of each foreground pixel.

Optionally, all the pixels in the initial image may be first preprocessed to screen out the foreground pixels, and the remaining regions are used as an image background without any further processing. Then the phasor candidate solution is determined for the foreground pixels, and then the initial phasor solution of the transition region is determined.

Optionally, determining the phasor candidate solution of each foreground pixel includes: determining a fitting error for each foreground pixel; and taking a phase vector of the fitting error corresponding to a local minimum as the phasor candidate solution. Taking chemical shift coded imaging performed by means of water-fat signal separation as an example, for each foreground pixel, the fitting error of the foreground pixel may be determined according to err(p)=∥S−A(p)A⁺(p)S∥₂², wherein err(p) is the fitting error, S is a collected water-fat signal, p is the phase vector (i.e. phasor), and A is a parameter matrix of a multi-point Dixon signal model. The local minimum of err(p) may be sought in a manner of traversing (−π,π] according to the above formula, and the phase vector of the fitting error corresponding to the local minimum is taken as the phasor candidate solution of the foreground pixel.

In some embodiments, determining the foreground pixels based on the pixel values of the pixels in the initial image includes: taking pixels with pixel values greater than a set amplitude value as the foreground pixels, wherein the set amplitude value is determined based on the pixel value of each pixel. The amplitude value may be determined according to the pixel values of all the pixels in the initial image, and the pixels with the pixel values greater than the amplitude value are screened out and taken as the foreground pixels. Optionally, the pixel values of all the pixels may be taken as the amplitude values. For example, the mean values and variances of all the pixels are taken as the amplitude values, or a maximum pixel value may further be determined, and a partial proportion of the maximum pixel value is taken as the amplitude value, for example, five percent of the maximum pixel value is taken as the amplitude value. A specific amplitude value setting manner may be set according to an actual situation, which is not limited herein.

S120, regional iterative phasor extraction is performed in at least two set directions by taking the initial phasor solution as initial information, and a target phasor solution is obtained based on a regional iterative phasor extraction result corresponding to each set direction.

As a whole, after the initial phasor solution of the transition region is obtained by means of solution, the initial phasor solution is taken as the initial information, the regional iterative phasor extraction is used in the at least two directions, such that at this point, wrong initial information is transferred in three different directions, while correct information is consistent in the three cases, the correct initial information is screened out through iteration in different directions, and thus the target phasor solution is obtained based on the correct initial information.

In an implementation of the present disclosure, performing regional iterative phasor extraction in the at least two set directions by taking the initial phasor solution as the initial information, and obtaining the target phasor solution based on the regional iterative phasor extraction result corresponding to each set direction includes: obtaining the corresponding regional iterative phasor extraction result by taking the initial phasor solution as the initial information and performing regional iterative phasor extraction respectively in the set direction; for each pixel, determining target phasor information of the pixel according to phasor information in each regional iterative phasor extraction result corresponding to the pixel; and determining a merged phasor solution based on the target phasor information of each pixel, and determining the target phasor solution based on the merged phasor solution.

Optionally, for each set direction, the regional iterative phasor extraction result corresponding to each set direction is obtained by performing the regional iterative phasor extraction by taking the initial phasor solution as the initial information, then the target phasor information corresponding to the pixel is determined according to the phasor information corresponding to the pixel in each regional iterative phasor extraction result, then the merged phasor solution is obtained by synthesizing the target phasor information of each pixel, and finally, the target phasor solution is determined based on the merged phasor solution. The set direction may be set according to practical requirements, and three directions perpendicular to each other may be set as the set direction.

In an implementation, obtaining the corresponding regional iterative phasor extraction result by taking the initial phasor solution as the initial information and performing the regional iterative phasor extraction respectively in the set direction includes: for each set direction, conducting Hamming window filtering on the initial phasor solution in the set direction to obtain a filtered phasor, and determining an iterative phasor solution of the phasor according to the filtered phasor, wherein a magnitude of a window function of the Hamming window filtering is determined according to a resolution of the initial image in the set direction; and taking the iterative phasor solution as new initial information, repeatedly executing the above steps until an iteration stop condition is reached, and determining the regional iterative phasor extraction result in the set direction.

Taking a single set direction as an example, it is assumed that the set direction is a direction corresponding to an xy plane, a solution of the transition region is taken as the initial information to determine phasor solutions of pixels in remaining regions by using regional iterative phasor extraction. The Hamming window filtering is conducted on the solution of the transition region along the xy plane, and the magnitude of the window function may be adjusted through L=k/r according to a resolution of image collection, where k=30 mm, and r is a resolution (unit: mm) of the image collected along a certain dimension. Exemplarily, when the resolution of collection in the xy plane is 3×3 mm², the magnitude of the window function used is 10×10. The initial information is filtered by the above window function to obtain the filtered phasor P_{filter}, and a candidate solution of the phasor is selected as the iterative phasor solution according to a filtering result:

$$p = \{ \begin{matrix}{p}_{1} , if \vert {p}_{filter} - {p}_{1} \vert < \vert {p}_{filter} - {p}_{2} \vert \\ {p}_{2} , if \vert {p}_{filter} - {p}_{2} \vert < \vert {p}_{filter} - {p}_{1} \vert\end{matrix}$$

Then, the current iterative phasor solution is taken as the initial information, the foregoing process is performed again until all the reserved pixels in the entire image are determined, and P_{s,1} is obtained and taken as the regional iterative phasor extraction result in the set direction.

For any set direction, the regional iterative phasor extraction result in the set direction may be obtained in the above manner.

In this embodiment, determining the target phasor information of the pixel according to the phasor information in each regional iterative phasor extraction result corresponding to the pixel includes: when the phasor information in each regional iterative phasor extraction result corresponding to the pixel is consistent, taking the phasor information in the regional iterative phasor extraction result as the target phasor information of the pixel; and when the phasor information in each regional iterative phasor extraction result corresponding to the pixel is inconsistent, setting zero as the target phasor information of the pixel.

It may be understood that, when the initial information is correct, the phasor information obtained by means of iteration in different directions is the same. On this basis, for each pixel, it is assumed that the phasor information corresponding to the pixel in each regional iterative phasor extraction result is consistent, which indicates that the initial information corresponding to the pixel is accurate, the consistent phasor information is taken as the target phasor information of the pixel; and it is assumed that the phasor information corresponding to the pixel in each regional iterative phasor extraction result is inconsistent, which indicates that the initial information corresponding to the pixel is inaccurate, 0 is set as the target phasor information of the pixel, so as to avoid an impact of the wrong information on the phasor solution.

On the basis of the above solution, determining the target phasor solution based on the merged phasor solution includes: obtaining the target phasor solution by performing regional iterative phasor extraction on the merged phasor solution. By means of the above solution, the merged phasor solution with the accurate initial information can be obtained, and then the regional iterative phasor extraction may be directly performed based on the merged phasor solution, so as to obtain the accurate target phasor solution. For a specific iteration manner, reference may be made to a regional iteration manner in the prior art, and reference may also be made to the regional iteration manner provided in the above embodiment, which is not limited here.

S130, a first chemical composition signal and a second chemical composition signal are determined based on the target phasor solution, and chemical shift coded imaging is performed based on the first chemical composition signal and/or the second chemical composition signal.

In this embodiment, after the accurate target phasor solution is obtained, calculation may be directly performed based on the target phasor solution to obtain a separated first chemical composition signal and second chemical composition signal, and then a chemical shift coded imaging result of a first chemical composition is obtained based on the first chemical composition signal for display. And/or, a chemical shift coded imaging result of a second chemical composition is obtained based on the second chemical composition signal for display.

Taking that the first chemical composition signal is a water signal and the second chemical composition signal is a fat signal as an example, a target water signal and a target fat signal may be separated through

$$[ \begin{matrix}W \\ F\end{matrix} ] = {A}^{+} ( ψ ) S ,$$

where W is the target water signal, and F is the target fat signal. After the target water signal and the target fat signal are separated, a water signal image may be generated based on the target water signal, a fat signal image may be generated based on the target fat signal, and the water signal image and the fat signal image are displayed.

According to technical solutions of this embodiment, the initial image is acquired, and the initial phasor solution of the transition region is determined based on the initial image; regional iterative phasor extraction is performed in the at least two set directions by taking the initial phasor solution as the initial information, and the target phasor solution is obtained based on the regional iterative phasor extraction result corresponding to each set direction; and the first chemical composition signal and the second chemical composition signal are determined based on the target phasor solution, and chemical shift coded imaging is performed based on the first chemical composition signal and/or the second chemical composition signal. By means of regional iterative phasor extraction in a plurality of dimensions, wrong phasor information is transferred independently along different dimensions, and then regional iterative phasor extraction results in a plurality of dimensions are merged to exclude wrong information transferred in different directions and reserve correct information consistent in each dimension, so as to solve the technical problems of poor stability and low accuracy of the separated chemical composition signals caused by difficulty in accurately acquiring the phasor information in a case where the initial information is uncertain, so that in the case where the initial information is uncertain, the separated chemical composition signals are more accurate, thereby improving a chemical shift coded imaging effect.

### Embodiment 2

Based on the above embodiment, this embodiment provides a preferred embodiment.

The embodiment of the present disclosure takes chemical shift coded imaging performed by means of water-fat separation as an example, and provides a method for accurately obtaining phasor information in a case where initial information is uncertain, thereby solving a problem of insufficient stability of water-fat separation in the scenario. As a whole, a phasor solution of a transition region is first calculated by means of a transition region extraction method or a seed point identification method, and the definition and the solution mode of which have been given in the aforementioned papers. After solving for a solution of the transition region, regional iterative phasor extraction is used in three directions along xy, xz and yz planes by taking the solution of the transition region as the initial information. At this point, the wrong initial information is transferred in three different directions, and the correct information is consistent in the three cases. The phasor solutions in the three cases are merged, the consistent phasor solution is reserved as the initial information, and finally, regional iterative phasor extraction is performed again to obtain a final phasor solution. In a case where the phasor solution is known, signals for each of water and fat are calculated.

Before performing the water-fat separation, a calculation manner of parameters in the water-fat separation is first determined.

For pixels containing both the water and the fat, a multi-point Dixon signal model may be represented as follows:

$${S}_{n} = ( W + F {\sum }_{p = 1}^{P} {α}_{p} {e}^{- i 2 π {f}_{F , p} {TE}_{n}} ) {e}^{- i 2 π ψ {TE}_{n}} \qquad ( 1 )$$

wherein Sn is a water-fat signal obtained by collection, W and F are the signals of the water and the fat respectively, P is the number of peaks in a fat multi-peak model, αₚ is a relative content of each fat peak, Σₚ₌₁^{p} αₚ=1, f_{F,p} is a resonance frequency offset of each fat peak relative to the water, ψ is a non-uniformity of a main magnetic field, TEₙ is echo time, and n is the number of echoes (at least 2).

The above formula may be rewritten in a matrix form, let

$$S = [ \begin{matrix}{S}_{1} \\ {S}_{2} \\ … \\ {S}_{n}\end{matrix} ] \qquad ( 2 )$$

$$A ( ψ ) = [ \begin{matrix}{e}^{- i 2 π ψ {TE}_{1}} & {e}^{- i 2 π ψ {TE}_{1}} {\sum }_{p = 1}^{P} {α}_{p} {e}^{- i 2 π {f}_{F , p} {TE}_{1}} \\ {e}^{- i 2 π ψ {TE}_{2}} & {e}^{- i 2 π ψ {TE}_{2}} {\sum }_{p = 1}^{P} {α}_{p} {e}^{- i 2 π {f}_{F , p} {TE}_{2}} \\ … & … \\ {e}^{- i 2 π ψ {TE}_{n}} & {e}^{- i 2 π ψ {TE}_{n}} {\sum }_{p = 1}^{P} {α}_{p} {e}^{- i 2 π {f}_{F , p} {TE}_{n}}\end{matrix} ] \qquad ( 3 )$$

$$ρ = [ \begin{matrix}W \\ F\end{matrix} ] \qquad ( 4 )$$

then the formula (1) is:

$$S = A ( ψ ) ρ \qquad ( 5 )$$

In the above equations, the unknowns are W, F and a field ψ, which may be obtained by a variable projection method, and after the field is obtained, the signals of the water and the fat may be calculated by a least square solution:

$$ρ = {A}^{+} ( ψ ) S \qquad ( 6 )$$

Since a term e^{-i2πψTE}^{ₙ} itself in the equation has periodicity, a phase vector may be used:

$$p = {e}^{i 2 π ψ Δ TE} \qquad ( 7 )$$

Through equivalent substitution, p is a unit vector having a direction. For the value of each given field, the following formula may be used to calculate the corresponding fitting error:

$$err ( p ) = {‖ S - A ( p ) {A}^{+} ( p ) S ‖}_{2}^{2} \qquad ( 8 )$$

A local minimum of err(p) is sought in a manner of traversing (−π,π], and the local minimum is a possible candidate solution of a phasor.

For a special case in the signal model, two-point water-fat separation may be slightly different. Nonetheless, the key to the problems in multi-point water-fat separation and two-point water-fat separation is how to judge the correct solution of the phasor, and therefore, the methods used in a multi-point water-fat separation model and a two-point water-fat separation model may be used universally.

After a magnetic resonance signal is collected, the possible phasor solution is obtained in a traversing manner. For a two-point application, a two-point parsing manner in the prior art may be used to obtain a parsing solution through calculation. After the candidate solution of the phasor is calculated, the solution of the transition region is obtained by using the transition region extraction method. In an application scenario of this embodiment, insufficient read bandwidth results in incomplete solving of the transition region, and errors may occur in the phasor solutions of some transition regions, thus it is difficult to obtain an accurate water-fat separation result by using an original water-fat transition region method. For the same reason, it is difficult for a regional iterative phasor extraction method based on a seed point to achieve the stable result.

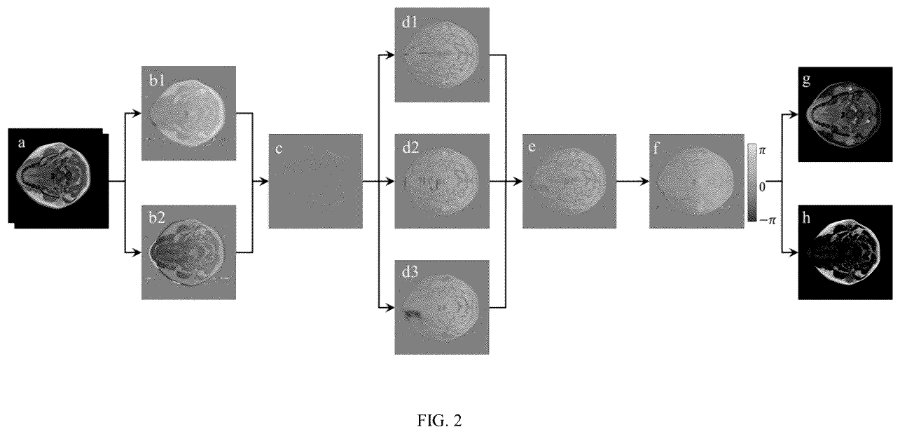

FIG. 2 is a schematic flow diagram of a chemical shift coded imaging method based on a transition region and regional iterative phasor extraction provided by Embodiment 2 of the present disclosure. The embodiment of the present disclosure provides a method based on transition region extraction and regional iterative phasor extraction, so as to implement stable water-fat signal separation. Referring to FIG. 2, the method includes the following specific steps:

1) firstly, all pixels in an image are pre-processed, pixels with signal strength meeting a certain condition (for example, an amplitude value is greater than 5% of a maximum signal amplitude value) are reserved, and other regions are taken as an image background without processing. For each reserved pixel, a fitting error thereof is calculated according to a manner shown in formula (8), wherein a phase vector corresponding to a local minimum value of the fitting error is a candidate solution of a phasor.

2) The candidate solutions of all the pixels in the image are classified, and the transition region and a solution of the transition region are calculated. Due to a bandwidth problem, detection of a transition region in a read-out direction is incomplete, and even an error occurs in some regions, resulting in that water-fat region partitioning and subsequent water-fat separation based on the transition region cannot be performed.

3) The solution of the transition region is taken as initial information to determine phasor solutions of pixels in remaining regions by using regional iterative phasor extraction. Hamming window filtering is conducted on the solution of the transition region along an xy plane, and a magnitude of a window function is adjusted according to a resolution of image collection:

$$L = k / r$$

where k=30 mm, and r is a resolution (unit: mm) of the image collected along a certain dimension. When the resolution of collection in the xy plane is 3×3 mm², the magnitude of the window function used is 10×10.

4) The initial information is filtered by the above window function to obtain a filtered phasor P_{filter}, and the candidate solution of the phasor is selected according to a filtering result:

$$p = \{ \begin{matrix}{p}_{1} , if \vert {p}_{filter} - {p}_{1} \vert < \vert {p}_{filter} - {p}_{2} \vert \\ {p}_{2} , if \vert {p}_{filter} - {p}_{2} \vert < \vert {p}_{filter} - {p}_{1} \vert\end{matrix}$$

then, a current phasor solution is taken as the initial information, this process is performed again until all the reserved pixels in the entire image are determined, and P_{s,1} is obtained.

5) In the same manner, the regional iterative phasor extraction is performed along a yz plane and an xz plane, so as to obtain P_{s,2} and P_{s,3} respectively.

6) Phase merging is performed on P_{s,1}, P_{s,2} and P_{s,3}. For any pixel, if the solutions in P_{s,1}, P_{s,2} and P_{s,3} are consistent, phasor information of the pixel is reserved; and if the solutions are inconsistent, the phasor information of the pixel is set to be zero, so as to obtain a merged phasor Pₛ.

7) Regional iterative phasor extraction is performed again on the merged phasor Pₛ, to obtain a final phasor solution P_{final}.

8) Final water and fat signals are calculated according to a final phasor result:

$$[ \begin{matrix}W \\ F\end{matrix} ] = {A}^{+} ( ψ ) S$$

W and F are the final separated water and fat signals.

In FIG. 2, (a) is an amplitude value of an original image, (b1) and (b2) are two candidate solutions of the phasor, (c) is the solution of the transition region, (d1)-(d3) are the field solutions obtained by using the regional iterative phasor extraction along the xz, yz, and xy planes respectively, (e) is the solution after merging, (f) is a solution obtained by performing regional iterative phasor extraction using (e) as the initial information, and (g) and (h) are respectively the signals of water and fat obtained through separation.

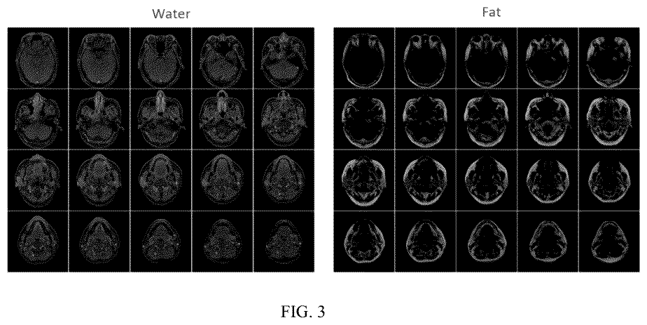

It should be noted that in order to verify the feasibility of the embodiment of the present disclosure, imaging has been performed by collecting sample data. Specifically, a collection sequence is T2_fse, B0=3T, and imaging parameters are: repetition time TR=2000 ms, a collection bandwidth of 220 Hz/pixel, a resolution of 0.5×0.5 mm², a layer thickness of 4 mm, the number of layers of 20, a flip angle of 130°, and TE=[0,0.839] ms. FIG. 3 is a schematic diagram of a chemical shift coded imaging result based on a transition region and regional iterative phasor extraction provided by Embodiment 2 of the present disclosure. FIG. 3 shows a processing result of the sample data. In FIG. 3, a left side is a water signal image, and a right side is a fat signal image. It can be seen from FIG. 3 that by using the method provided in this embodiment, water and fat signals can be separated stably without tissues with obvious separation errors.

On the basis of the above embodiment, the signal model in formula (1) may be changed, so that the method executed based on the changed signal model may be used for chemical shift coded imaging methods corresponding to other chemical shift compositions.

According to the technical solution of this embodiment, the magnitude of the window function is adaptively adjusted according to the resolution of the collected image in various image dimensions, and a selection range of the echo collection time is flexible, which can achieve faster collection efficiency. By means of regional iterative phasor extraction in a plurality of dimensions, the wrong phasor information is transferred along different dimensions independently, making an algorithm more stable against an initial information error.

### Embodiment 3

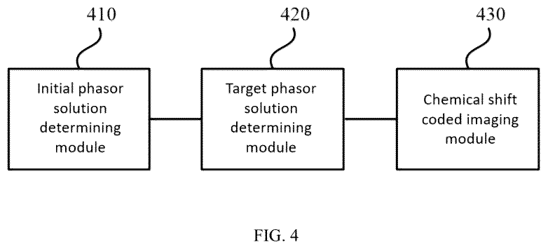

FIG. 4 is a schematic structural diagram of a chemical shift coded imaging apparatus based on a transition region and regional iterative phasor extraction provided by Embodiment 3 of the present disclosure. As shown in FIG. 4, the apparatus includes an initial phasor solution determining module 410, a target phasor solution determining module 420, and a chemical shift coded imaging module 430, wherein
the initial phasor solution determining module 410 is configured to acquire an initial image, and determine an initial phasor solution of the transition region based on the initial image;
the target phasor solution determining module 420 is configured to perform regional iterative phasor extraction in at least two set directions by taking the initial phasor solution as initial information, and obtain a target phasor solution based on a regional iterative phasor extraction result corresponding to each set direction; and
the chemical shift coded imaging module 430 is configured to determine a first chemical composition signal and a second chemical composition signal based on the target phasor solution, and perform chemical shift coded imaging based on the first chemical composition signal and/or the second chemical composition signal.

According to technical solutions of this embodiment, the initial image is acquired, and the initial phasor solution of the transition region is determined based on the initial image; regional iterative phasor extraction is performed in the at least two set directions by taking the initial phasor solution as the initial information, and the target phasor solution is obtained based on the regional iterative phasor extraction result corresponding to each set direction; and the first chemical composition signal and the second chemical composition signal are determined based on the target phasor solution, and chemical shift coded imaging is performed based on the first chemical composition signal and/or the second chemical composition signal. By means of regional iterative phasor extraction in a plurality of dimensions, wrong phasor information is transferred independently along different dimensions, and then regional iterative phasor extraction results in a plurality of dimensions are merged to exclude wrong information transferred in different directions and reserve correct information consistent in each dimension, so as to solve the technical problems of poor stability and low accuracy of the separated chemical composition signals caused by difficulty in accurately acquiring the phasor information in a case where the initial information is uncertain, so that in the case where the initial information is uncertain, the separated chemical composition signals are more accurate, thereby improving a chemical shift coded imaging effect.

On the basis of the above embodiments, optionally, the initial phasor solution determining module 410 is specifically configured to:
determine foreground pixels based on pixel values of pixels in the initial image, and determine a phasor candidate solution of each foreground pixel; and
determine the transition region and the initial phasor solution of the transition region based on the phasor candidate solution of each foreground pixel.

On the basis of the above embodiments, optionally, the initial phasor solution determining module 410 is specifically configured to:
take pixels with pixel values greater than a set amplitude value as the foreground pixels, wherein the set amplitude value is determined based on the pixel value of each pixel.

On the basis of the above embodiments, optionally, the target phasor solution determining module 420 is specifically configured to:
obtain the corresponding regional iterative phasor extraction result by taking the initial phasor solution as the initial information and performing regional iterative phasor extraction respectively in the set direction;
determine, for each pixel, target phasor information of the pixel according to phasor information in each regional iterative phasor extraction result corresponding to the pixel; and
determine a merged phasor solution based on the target phasor information of each pixel, and determine the target phasor solution based on the merged phasor solution.

On the basis of the above embodiments, optionally, the target phasor solution determining module 420 is specifically configured to:
conduct, for each set direction, Hamming window filtering on the initial phasor solution in the set direction to obtain a filtered phasor, and determine an iterative phasor solution of the phasor according to the filtered phasor, wherein a magnitude of a window function of the Hamming window filtering is determined according to a resolution of the initial image in the set direction; and
take the iterative phasor solution as new initial information, repeatedly execute the above steps until an iteration stop condition is reached, and determine the regional iterative phasor extraction result in the set direction.

On the basis of the above embodiments, optionally, the target phasor solution determining module 420 is specifically configured to:
take, when the phasor information in each regional iterative phasor extraction result corresponding to the pixel is consistent, the phasor information in the regional iterative phasor extraction result as the target phasor information of the pixel; and
set, when the phasor information in each regional iterative phasor extraction result corresponding to the pixel is inconsistent, zero as the target phasor information of the pixel.

On the basis of the above embodiments, optionally, the target phasor solution determining module 420 is specifically configured to:
obtain the target phasor solution by performing regional iterative phasor extraction on the merged phasor solution.

The chemical shift coded imaging apparatus based on the transition region and the regional iterative phasor extraction provided in the embodiment of the present disclosure can execute the chemical shift coded imaging method based on the transition region and the regional iterative phasor extraction provided in any embodiment of the present disclosure, and has the corresponding functional modules and beneficial effects during executing the method.

### Embodiment 4

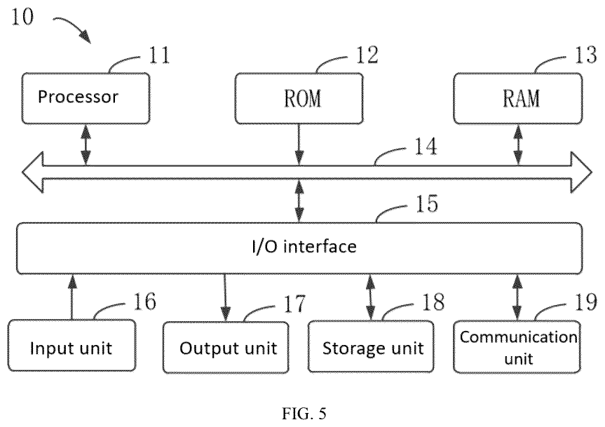

FIG. 5 is a schematic structural diagram of an electronic device provided by Embodiment 4 of the present disclosure. The electronic device 10 aims to express various forms of digital computers, such as a laptop computer, a desk computer, a work bench, a personal digital assistant, a server, a blade server, a mainframe computer and other proper computers. The electronic device may further express various forms of mobile apparatuses, such as a personal digital assistant, a cellular phone, an intelligent phone, a wearable device (such as a helmet, glasses, and a watch) and other similar computing apparatuses. Components shown herein, their connection and relations, and their functions only serve as an example, and are not intended to limit implementation of the present disclosure described and/or required herein.

As shown in FIG. 5, the electronic device 10 includes at least one processor 11, and a memory in communication connection with the at least one processor 11, such as a read-only memory (ROM) 12 and a random access memory (RAM) 13. The memory stores a computer program executable by the at least one processor, and the processor 11 may perform various appropriate actions and processing according to the computer program stored in the read-only memory (ROM) 12 or a computer program loaded from a storage unit 18 into the random access memory (RAM) 13. In the RAM 13, various programs and data required by operation of the electronic device 10 may further be stored. The processor 11, the ROM 12, and the RAM 13 are connected to each other through a bus 14. An input/output (I/O) interface 15 is also connected to the bus 14.

A plurality of components in the electronic device 10 are connected to the I/O interface 15, including: an input unit 16, such as a keyboard and a mouse; an output unit 17, such as various types of displays and speakers; the storage unit 18, such as a magnetic disc and an optical disc; and a communication unit 19, such as a network card, a modem, and a wireless communication transceiver. The communication unit 19 allows the electronic device 10 to exchange information/data with other devices through a computer network such as the Internet and/or various telecommunication networks.

The processor 11 may be various general and/or dedicated processing components with processing and computing capabilities. Some examples of the processor 11 include but are not limited to a central processing unit (CPU), a graphic processing unit (GPU), various dedicated artificial intelligence (AI) computing chips, various processors running a machine learning model algorithm, a digital signal processor (DSP), and any proper processor, controller, microcontroller, etc. The processor 11 executes the various methods and processing described above, such as the chemical shift coded imaging method based on the transition region and the regional iterative phasor extraction.

In some embodiments, the chemical shift coded imaging method based on the transition region and the regional iterative phasor extraction may be implemented as a computer program that is tangibly included in a computer readable storage medium such as the storage unit 18. In some embodiments, part of or all the computer program may be loaded into and/or mounted on the electronic device 10 via the ROM 12 and/or the communication unit 19. When the computer program is loaded to the RAM 13 and executed by the processor 11, one or more steps of the chemical shift coded imaging method based on the transition region and the regional iterative phasor extraction described above may be executed. Alternatively, in other embodiments, the processor 11 may be configured to execute the chemical shift coded imaging method based on the transition region and the regional iterative phasor extraction through any other proper modes (for example, by means of firmware).

The various implementations of the systems and technologies described above herein may be implemented in a digital electronic circuit system, an integrated circuit system, a field programmable gate array (FPGA), an application-specific integrated circuit (ASIC), an application specific standard product (ASSP), a system on chip (SOC), a complex programmable logic device (CPLD), computer hardware, firmware, software, and/or combinations thereof. These various implementations may include: implementing in one or more computer programs, wherein the one or more computer programs are executable and/or interpretable on a programmable system including at least one programmable processor, and the programmable processor may be a dedicated or general-purpose programmable processor, may receive data and instructions from a storage system, at least one input apparatus, and at least one output apparatus, and transmit the data and the instructions to the storage system, the at least one input apparatus, and the at least one output apparatus.

The computer programs for implementing the chemical shift coded imaging method based on the transition region and the regional iterative phasor extraction of the present disclosure may be written in any combination of one or more programming languages. These computer programs may be provided to processors of a general-purpose computer, a special-purpose computer, or other programmable data processing apparatuses, so that the computer programs, when executed by the processor, cause functions/operations specified in flow diagrams and/or block diagrams to be implemented. The computer programs may be executed entirely on machines, partially on machines, partially on machines as independent software packages, partially on remote machines, or entirely on remote machines or servers.

### Embodiment 5

Embodiment 5 of the present disclosure further provides a computer readable storage medium, the computer readable storage medium stores computer instructions, and the computer instructions are used to cause a processor to execute a chemical shift coded imaging method based on a transition region and regional iterative phasor extraction. The method includes:
acquiring an initial image, and determining an initial phasor solution of the transition region based on the initial image;
performing regional iterative phasor extraction in at least two set directions by taking the initial phasor solution as initial information, and obtaining a target phasor solution based on a regional iterative phasor extraction result corresponding to each set direction; and
determining a first chemical composition signal and a second chemical composition signal based on the target phasor solution, and performing chemical shift coded imaging based on the first chemical composition signal and/or the second chemical composition signal.

In the context of the present disclosure, the computer readable storage medium may be a tangible medium that may contain or store computer programs for use by or in combination with an instruction execution system, apparatus, or device. The computer readable storage medium may include, but is not limited to, an electronic, magnetic, optical, electromagnetic, infrared, or semiconductor system, apparatus, or device, or any suitable combination of the above content. Alternatively, the computer readable storage medium may be a machine readable signal medium. More specific examples of the machine readable storage medium include electrical connections based on one or more wires, a portable computer disk, a hard drive, a random access memory (RAM), a read-only memory (ROM), an erasable programmable read-only memory (EPROM or a flash memory), an optical fiber, a portable compact disc read-only memory (CD-ROM), an optical storage device, a magnetic storage device, or any suitable combination of the above content.

In order to provide interaction with a user, the system and technology described here may be implemented on an electronic device. The electronic device has a display apparatus (such as a cathode ray tube (CRT) or a liquid crystal display (LCD) monitor) for displaying information to the user; and a keyboard and a pointing apparatus (such as a mouse or a trackball). The user may provide input to the electronic device through the keyboard and the pointing apparatus. Other types of apparatuses may further be used to provide interaction with the user. For example, feedback provided to the user may be any form of sensory feedback (such as visual feedback, auditory feedback, or tactile feedback); and the input from the user may be received in any form (including sound input, speech input, or tactile input).

The system and technology described here may be implemented in a computing system that includes backend components (such as serving as a data server), or a computing system that includes middleware components (such as an application server), or a computing system that includes frontend components (such as a user computer with a graphical user interface or a web browser, wherein the user can interact with the implementation of the system and technology described here through the graphical user interface or the web browser), or a computing system that includes any combination of such backend components, middleware components, or frontend components. The components of the system may be interconnected through any form or medium of digital data communication (such as a communication network). Examples of the communication network include a local area network (LAN), a wide area network (WAN), a blockchain network, and the Internet.

The computing system may include a client and a server. The client and the server are generally away from each other and usually interact through the communication network. A relationship of the client and the server is generated through computer programs run on a corresponding computer and mutually having a client-server relationship. The server may be a cloud server, also referred to as a cloud computing server or a cloud host, and is a host product in a cloud computing service system to overcome defects of difficult management and weak business expansion in a traditional physical host and VPS service.

It should be understood that various forms of flows shown above may be used to reorder, increase or delete the steps. For example, all the steps recorded in the present disclosure may be executed in parallel, may also be executed sequentially or in different sequences, as long as the expected result of the technical solution of the present disclosure may be implemented, which is not limited herein.

The above specific implementation does not constitute the limitation to the scope of protection of the present disclosure. It should be understood by those skilled in the art that various modifications, combinations, sub-combinations and substitutions may be made according to design requirements and other factors. Any modification, equivalent replacement, improvement and the like made within the spirit and principle of the present disclosure shall all be contained in the scope of protection of the present disclosure.

What is claimed is:

1. A chemical shift coded imaging method based on a transition region and regional iterative phasor extraction, comprising:
acquiring an initial image, and determining an initial phasor solution of the transition region based on the initial image;
performing regional iterative phasor extraction in at least two set directions by taking the initial phasor solution as initial information, and obtaining a target phasor solution based on a regional iterative phasor extraction result corresponding to each set direction; and
determining a first chemical composition signal and a second chemical composition signal based on the target phasor solution, and performing chemical shift coded imaging based on the first chemical composition signal and/or the second chemical composition signal.

2. The method according to claim 1, wherein determining the initial phasor solution of the transition region based on the initial image comprises:
determining foreground pixels based on pixel values of pixels in the initial image, and determining a phasor candidate solution of each foreground pixel; and
determining the transition region and the initial phasor solution of the transition region based on the phasor candidate solution of each foreground pixel.

3. The method according to claim 2, wherein determining the foreground pixels based on the pixel values of the pixels in the initial image comprises:
taking pixels with pixel values greater than a set amplitude value as the foreground pixels, wherein the set amplitude value is determined based on the pixel value of each pixel.

4. The method according to claim 1, wherein performing regional iterative phasor extraction in the at least two set directions by taking the initial phasor solution as the initial information, and obtaining the target phasor solution based on the regional iterative phasor extraction result corresponding to each set direction comprises:
obtaining the corresponding regional iterative phasor extraction result by taking the initial phasor solution as the initial information and performing regional iterative phasor extraction respectively in the set direction;
determining, for each pixel, target phasor information of the pixel according to phasor information in each regional iterative phasor extraction result corresponding to the pixel; and
determining a merged phasor solution based on the target phasor information of each pixel, and determining the target phasor solution based on the merged phasor solution.

5. The method according to claim 4, wherein obtaining the corresponding regional iterative phasor extraction result by taking the initial phasor solution as the initial information and performing regional iterative phasor extraction respectively in the set direction comprises:
conducting, for each set direction, Hamming window filtering on the initial phasor solution in the set direction to obtain a filtered phasor, and determining an iterative phasor solution of the phasor according to the filtered phasor, wherein a magnitude of a window function of the Hamming window filtering is determined according to a resolution of the initial image in the set direction; and
taking the iterative phasor solution as new initial information, repeatedly executing the above steps until an iteration stop condition is reached, and determining the regional iterative phasor extraction result in the set direction.

6. The method according to claim 4, wherein determining the target phasor information of the pixel according to the phasor information in each regional iterative phasor extraction result corresponding to the pixel comprises:
taking, when the phasor information in each regional iterative phasor extraction result corresponding to the pixel is consistent, the phasor information in the regional iterative phasor extraction result as the target phasor information of the pixel; and
setting, when the phasor information in each regional iterative phasor extraction result corresponding to the pixel is inconsistent, zero as the target phasor information of the pixel.

7. The method according to claim 4, wherein determining the target phasor solution based on the merged phasor solution comprises:
obtaining the target phasor solution by performing regional iterative phasor extraction on the merged phasor solution.

8. A chemical shift coded imaging apparatus based on a transition region and regional iterative phasor extraction, comprising:
an initial phasor solution determining module, configured to acquire an initial image, and determine an initial phasor solution of the transition region based on the initial image;
a target phasor solution determining module, configured to perform regional iterative phasor extraction in at least two set directions by taking the initial phasor solution as initial information, and obtain a target phasor solution based on a regional iterative phasor extraction result corresponding to each set direction; and
a chemical shift coded imaging module, configured to determine a first chemical composition signal and a second chemical composition signal based on the target phasor solution, and perform chemical shift coded imaging based on the first chemical composition signal and/or the second chemical composition signal.

9. An electronic device, comprising:
at least one processor; and
a memory in communication connection with the at least one processor, wherein
the memory stores a computer program executable by the at least one processor, and the computer program is executed by the at least one processor, such that the at least one processor is capable of executing the chemical shift coded imaging method based on the transition region and the regional iterative phasor extraction according to claim 1.

10. A computer readable storage medium, wherein the computer readable storage medium stores computer instructions, and the computer instructions are used to cause, when executed by the processor, the processor to implement the chemical shift coded imaging method based on the transition region and the regional iterative phasor extraction according to claim 1.
